(19) United States
(12) Patent Application Publication
(10) Pub. No.: US 2006/0237974 A1
(43) Pub. Date: Oct. 26, 2006

(54) Modular latch

(75) Inventors: Wolfgang Hamm, Mauden (DE); Jochen Grunschlag, Daaden (DE); Jorg Moller-Gaden, Siegen (DE); Markus Ermert, Burbach (DE); Ulrich Lotz, Neunkirchen (DE); Michael Stockschlader, Herdorf (DE)

Correspondence Address: THE FIRM OF KARL F ROSS, 5676 RIVERDALE AVENUE, PO BOX 900, RIVERDALE (BRONX), NY, 10471-0900, US

(73) Assignee: THOMAS MAGNETE GmbH

(21) Appl. No.: 11/407,408

(22) Filed: Apr. 19, 2006

(30) Foreign Application Priority Data
Apr. 22, 2005 (EP) 05008834.3

(51) Int. Cl. E05C 3/06

(52) U.S. Cl. 292/216

(57) ABSTRACT

A device for locking and quickly unlocking of relatively movable parts has an actuator having an electromagnet with a movable core and a latch coupled or operatively connected on the one side to the actuator or the movable core and on the other side to the movable part, the latch having pawls pivotal on fixed axles. A fixedly mounted housing has a seat fitted to the actuator or the electromagnet such that the actuator or the electromagnet is held immobile and unmovably in the seat. The axles for the pawls of the latch are formed in the housing, and the housing has a cutout for engagement of one of the movable parts part and one of the pawls. A plug on the housing fits with external connecting means, and connecting parts on the housing connect the actuator to the plug on the housing.

### FIELD OF THE INVENTION

The present invention relates to a modular latch. More particularly this invention concerns a device for locking and unlocking relatively movable parts.

### BACKGROUND OF THE INVENTION

A device for locking and quickly unlocking relatively movable parts typically comprises an actuator, particularly an electromagnet with movable core, and a latch that is coupled to or operatively connected on the one side to the actuator, particularly to the movable core, and on the other side to the movable part, wherein the pawls of the latch are pivotal on fixed axles and the parts of the device are held in a housing that is fixedly mounted and that carries the movable parts, wherein the device alternatively comprises an electronic controller.

Such devices are described for example in DE 198 21 594 C2 and EP 1 488 965 A1.

Such devices serve to release rapidly moving parts, particularly safety components. Thus they are used in motor vehicles to secure a roll bar or a comfort releases for example to release a roll bar of motor vehicles, a head restraint, a bumper, a seat belt tensioner, a seat adjuster, seat release or even to hold vehicle body parts, for example hood, trunk lid, convertible top, doors or the like. From DE 198 21 594 it is known to attach the parts of the latch to a retainer. Then the actuator is formed by an electromagnet that is triggered by a sensor or a switch, so that in case of a corresponding impulse or signal the movable core of the magnetic inductor moves out of the electromagnet and operates the latch such that a part held by the latch is released and can shift correspondingly under the force of a pretensioned spring or under the effect of an external force.

From EP 1 488 965 A1 it is known to arrange the latch and the actuator in a module that can be formed as closed box.

With the known systems an individual arrangement and attachment of the functional components in the housing is necessary, which involves large assembly costs and high manufacturing inaccuracies, because the mounting accuracy depends on how accurate and under what tolerances the single parts are attached in the housing. In addition the electrical hookup of the actuator is to be carried out separately inside the housing, so that different connecting arrangements inside the housing have to be provided for every different application.

At the same time it is also usual to manufacture the actuator, particularly the electromagnet, with a customized plug, so that different actuators with plugs have to be manufactured for every customer and purpose.

### OBJECTS OF THE INVENTION

On the basis of this state of the art it is an object 5 of the invention to create a device of this kind that can be mounted and assembled in a simple manner with high accuracy, wherein single functional parts are interchangeable, all functional parts are located in one housing and the individual -connections for external power sources or the like are accessible from outside the housing.

### SUMMARY OF THE INVENTION

To solve this problem it is proposed that the housing has a seat fitted to the actuator or the electromagnet, the actuator or the electromagnet being held immobile and unmovably in the seat, pivots for all pawls of the latch are formed in the housing around which the pawls are limitedly pivoted and on which the pawls are mounted, the housing having connecting parts for connecting the actuator to a plug mounted to or molded onto the housing, the plug being made to fit with external connecting means, and the housing: having a cutout for engagement of a part that is to be brought into engagement with the latch.

Due to the fact that the housing has a seat fitted to the actuator or the electromagnet, it is possible to insert the corresponding part into the seat of the housing so that an efficient and exact fit inside the housing is ensured immediately without further measures being required for it. Inaccuracies that could result from an inept handling are avoided this way. In addition the pivots for all pawls of the latch are formed in the housing, so that also mounting of the pawls of the latch can be carried out in a simple manner and extremely accurately without individual faults. In addition the electrical connection and wiring of the actuator are also carried out as is standard with a plug mounted to or molded onto the housing, so that the same actuator can be used for various applications, only the housing and the housing-mounted plug being custom made according to the customer's demands.

During design only the housing and, if necessary, the plug is correspondingly adapted to the individual purpose or customer request. The parts that are mounted inside the housing can always be identical, with corresponding installation places provided inside the housing.

As known, the housing has a cutout for the engagement of the part that is to be brought into engagement with the latch. With the device an unlocking system is provided that forms a compact, closed unit and in which single functional parts of the unit are interchangeable.

In a known manner it is provided that the latch has an actuating pawl that can be actuated directly by the actuator, has a locking pawl that is in operative connection with the actuating pawl and with a retaining pawl, as well as a retaining pawl that is in operative connection with the locking pawl and to the part that is to be latched.

As a preferred embodiment, the pivots for the actuating pawl and for the locking pawl are formed by bolts mounted to or molded onto the housing.

Due to the fact that the corresponding bolts or the like are mounted to the housing, particularly molded onto the housing, tolerances during the installation and the attachment of the bolts are avoided, because no tolerances between the installation of the bolts and the molding of the seat for the reception of the actuator develop especially with unitary molding of the bolts.

It is particularly preferred that a mount for the retaining pawl is formed by a bolt reaching through the housing at its journals, the bolt being fixed or mounted to housing-mounted parts of a part that is part of an element to which the movable part is mounted.

This embodiment ensures that this main bolt takes over the function of force transfer and adjustment of the system during installation at the corresponding part. The corresponding part to which the device is mounted has a complementary recess or seat in which the ends of the bolt can be mounted or fixed. With this the whole system then is adjusted with respect to the parts that are to be moved, the force transmission of the system occurring mainly, almost exclusively, at this bolt, but not via housing parts or other parts of the device.

In addition the housing consists of a lower part and an upper part, wherein both parts are connectable, latchable, engageable, welded, or glued to each other and surround and enclose all functional parts.

It can also be provided that the housing parts form a sealed housing by installation of at least one seal, wherein merely the cutout, in which lies the end of the retaining pawl, is open to the outside, so that the part that is to be brought into engagement with the retaining pawl can engage in the cutout.

Above all such an arrangement is then necessary and helpful when a need for increased protection against intrusion of contaminants and/or fluids exists.

Perhaps it is also sufficient, if only for the positioning of the actuator, particularly of the electromagnet, when it is closed off to the outside by a seal that is mounted between the housing parts in the area surrounding the actuator.

To further simplify manufacture the connecting parts for connecting the actuator to the plug are formed by contacts, pressed screens, cables, rigid or flexible circuit boards or such elements suitable for carrying current and molded into or inserted into the housing. The circuit boards are particularly formed as printed circuits.

In addition the housing can consist of primary formed parts.

The housing can for example be extruded of plastic or be cast. Obviously it is also possible to punch and/or to form an appropriate housing of steel.

Furthermore a holder for a sensor or switch for diagnosis purposes is provided in the housing, in which a sensor or switch is inserted and secured, wherein the sensor or switch is operable or can be affected by one of the pawls of the latch and is coupled to an electronic part.

It is also provided that a spring is mounted between the actuating pawl and the retaining pawl that is pretensioned in case of a tensioned, not actuated device.

For example a coil spring or a leg spring can be inserted as spring. It is also possible to assign a spring to each the actuating pawl as well as the retaining pawl that is supported for example by housing parts, to fix the pawls in its position, when the actuator is not current fed, and to reset the pawls in its starting position after current feeding of the actuator respectively.

It can be further provided that the housing has brackets or seats for mounting elements, by means of which the housing is racked-fixedly attachable to surrounding parts.

It can also be provided that a holder for an electronic controller is provided in the housing.

For an individual formation of the device depending on the customer desires it is simply required to produce the corresponding housing, if necessary, with a molded customized connector plug. In this housing the standardized parts of the latch as well as the actuator and such parts can be then inserted. By corresponding calculation or by formation of webs or the like in the area of the seat for the reception of the actuator it is also possible to install differently calculated actuators and to hold them secure in their position. For different demands of unlocking this device can quickly be adapted, because a lot of equal parts are used and functional parts are standardized. In the usual way the device can be latched reversibly. In the customary devices the device can be quickly adapted to the particular construction space including the individual fixing, because merely the housing with, if necessary, the connector plug is to manufacture individually, while the functional elements are standardized parts. Due to the modular design according to the invention expenses for the development can be kept down, wherein for example one type of actuator can be used for different customers and can be mounted on one and the same automatic production line. The customer receives an unlocking unit as black box that can quickly be installed. The force transmission of the system occurs through the part that is to be latched, into the latch and onto the bolt that supports the retaining pawl, wherein this bolt is mounted and supported by vehicle body parts or the like, so that a direct force transmission into the surrounding parts occurs. The loading of the housing and of the rest of the parts of the device are negligible compared to that.

### BRIEF DESCRIPTION OF THE DRAWING

Embodiments of the invention are shown in the drawing and described in more detail in the following. Therein:

FIG. 1 is a first embodiment of the device in a view with an open housing;

FIG. 2 is a variation in the same view

FIG. 3 is another variation in the same view;

FIG. 4 is the variation with a closed housing.

### SPECIFIC DESCRIPTION

In the drawing a device for locking and quickly unlocking of relatively movable parts is shown. Such devices serve particularly to latch or unlatch safety parts of motor vehicles in case of a crash or for convenience such as roll bars, head restraints, bumpers, seat belt tensioners, seat adjusters, seat releases or the like. The device consists of an actuator 1, particularly an electromagnet with movable core la as well as a latch with an actuating pawl 2 that can be actuated by the movable core la, a locking pawl 3 that is latched by the actuating pawl in the normal position of use and is released by the actuating pawl 2 in case of a crash or a comfort release, wherein the locking pawl 3 latches a retaining pawl 4 in the normal position of use and releases it during a comfort release or in a position actuated by the actuator 1 due to a crash, so that it is adjusted to the activation position under the force of an adjustment spring or the like. The retaining pawl 4 has a mouth in which a clamp, bolt or the like of the part that is to be secured is held. The pawls 2 to 4 are pivotal on respective fixed axles. All parts are mounted in a housing that consists of a shell 11 and a further shell 7 covering the shell. The shells 7 and 11 together form a seat fitted to the actuator 1, in which the actuator is held immobile and nonmovable.

The seat of the housing can be constituted by a corresponding shape of the housing as illustrated for example in FIG. 1. Pivots for all pawls 2 to 4 of the latch are formed in the housing, around which the pawls 2 to 4 are limitedly pivoted. In addition the pawls 2 to 4 are secured to the corresponding pivots. Additionally connecting parts are mounted in the housing, by means of which the actuator 1 is connected to a plug 5 mounted on the housing or formed in one part with the housing. Like the shells, the plug 5 is also formed as an individual part that corresponds to the consumer's needs. The elements mounted in the housing are, independently of the form of the housing and the formation of the plug 5, the same, so that mass production in modular design is made possible. Additionally the housing has a cutout 13 through which the locking end of the retaining pawl 4 is accessible and/or in which cutout an element that is to be latched can fit for engagement with the retaining pawl 4.

The pivot for the actuating pawl 2 and also the pivot for the locking pawl 3 are formed by respective bolts 14 and 15 molded onto the housing. These bolts are molded onto the shell, while the other shell has a corresponding seat for the ends of the bolts. With this formation an exact orientation of the actuator 1 to the actuating pawl 2 and the locking pawl 3 is achieved, so that a simple exact adjustment is carried out during the assembly.

The pivot for the retaining pawl 4 is formed by a bolt 12 reaching through the housing at the pivots that protrude on both sides of the housing and fixed or mounted to housing-mounted parts, for example of a motor vehicle. Because of this it is possible to adjust the system in a simple manner during installation of the device in a corresponding motor vehicle or the like, and also load transmission occurs directly through this bolt 12 to the structure of the vehicle body or the like, so that the device is otherwise not affected by the actuation or locking forces.

Both shells 7 and 11 are for example locked to each other. It is also possible to arrange in the cavity of the housing between both shells 7 and 11 a seal also for the area surrounding the bolt 12 (seal 10), so that an intrusion of dust or moisture into the housing is prevented with the exception of the area of the cutout 13.

It is also sufficient in some circumstances to seal only the mounting location of the actuator, especially the electromagnet, with respect to the outside with a seal that is mounted between the housing parts in the area surrounding the actuator.

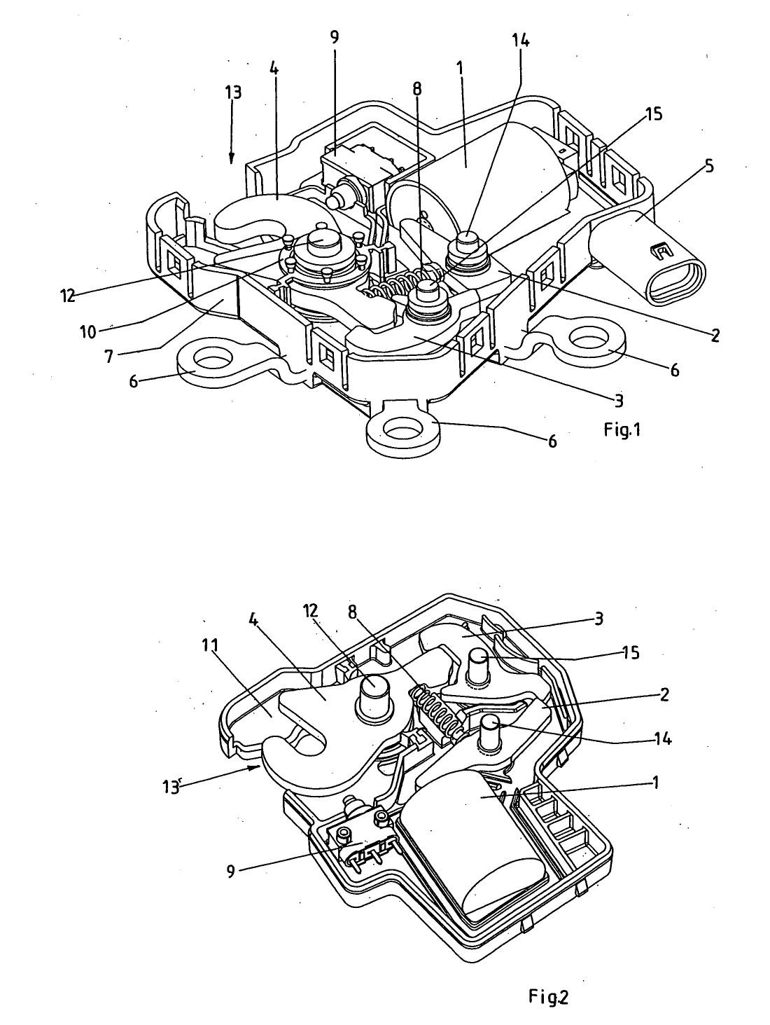

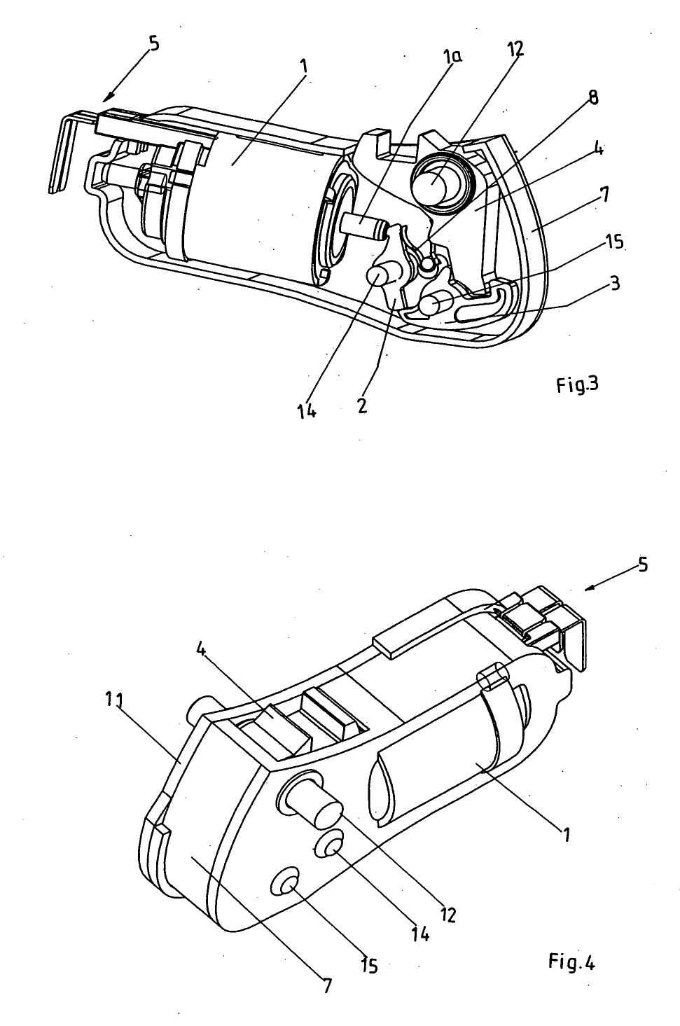

Additionally the shells 7 and 11 of the housing form a contoured holder for a sensor or switch 9 that is also securely held right in position by this installation place. Furthermore a spring 8 is provided between the actuating pawl 2 and the retaining pawl 4 by means of which a return of the actuating pawl 2 in the starting position that is shown in the drawings occurs during the locking of the retaining pawl 4 to the corresponding motor vehicle part. In the FIGS. 1 and 2 the spring 8 is a coil spring. In FIG. 3 spring 8 is a torque spring.

The invention is not limited to the embodiment, but multiply variable within the scope of the disclosure.

All new features, single or combined, and disclosed in the description and/or drawing are considered as relevant to the invention.

We claim:

1. A device for locking and quickly unlocking of relatively movable parts, the device comprising:
an actuator having an electromagnet with a movable core;
a latch coupled or operatively connected on the one side to the actuator or the movable core and on the other side to the movable part, the latch having pawls pivotal on fixed axles;
a fixedly mounted housing having a seat fitted to the actuator or the electromagnet such that the actuator or the electromagnet is held immobile and unmovably in the seat, the axles for the pawls of the latch being formed in the housing, the housing having a cutout for engagement of one of the movable parts part and one of the pawls;
a plug on the housing fittable with external connecting means; and
connecting parts on the housing for connecting the actuator to the plug on the housing.

2. The device defined in claim 1 wherein the latch has an actuating pawl that can be actuated directly by the actuator, has a locking pawl that is in operative connection with the actuating pawl, and a retaining pawl that is in operative connection with the locking pawl and the part that is to be latched.

3. The device defined in claim 2 wherein the axles for the actuating pawl and for the locking pawl are formed by bolts mounted to or molded onto the housing.

4. The device defined in claim 2 wherein the axle for the retaining pawl is formed by a bolt through the housing at its ends, wherein the bolt is fixed or mounted to housing-mounted parts of a part that is part of an element to which the movable part is mounted.

5. The device defined in claim 1 wherein the housing consists of a lower part and an upper part connected together and surrounding the latch and actuator.

6. The device defined in claim 5 wherein housing parts form a sealed unit having at least one seal, only the cutout in which lies the end of one of the pawls is open to the outside, so that the part that is to be brought into engagement with the one pawl can engage in the cutout.

7. The device defined in claim 5 wherein only the holder of the actuator is sealed to the outside by a seal that is mounted between the housing parts in the area surrounding the actuator.

8. The device defined claim 7 wherein the connecting parts for connecting the actuator to the plug are formed by contacts, pressed screens, cables, rigid or flexible circuit boards or such elements suitable for current-carrying molded into or inserted into the housing.

9. The device defined in claim 1 wherein the housing consists of primary formed parts.

10. The device defined in claim 1, further comprising
a sensor for diagnosis purposes, the housing forming a contoured holder in which the sensor fits and is secured, the sensor being operable by one of the pawls of the latch and being coupled to one or several electronic parts.

11. The device defined in claim 2, further comprising
a spring mounted between the actuating pawl and the retaining pawl.

12. The device defined in claim 1 wherein the housing has brackets or seats for mounting elements, by means of which the housing is fixable to surrounding parts.

13. The device defined in claim 1 wherein a holder for an electronic controller is provided in the housing.

14. The device defined in claim 13 wherein the connecting parts for electrically connecting the actuator to the control electronics are formed by pressed screens or by rigid or flexible circuit boards or cables or other elements suitable for current-carrying molded into or inserted into the housing.
